(19) United States
(12) Patent Application Publication
(10) Pub. No.: US 2022/0038833 A1
(43) Pub. Date: Feb. 3, 2022

(54) METHOD FOR ESTABLISHING A SHORT-RANGE RADIO LINK, AND HEARING DEVICE AND CHARGING UNIT

(71) Applicant: Sivantos Pte. Ltd., Singapore (SG)

(72) Inventors: Stefan Menzl, Hersbruck (DE); Thomas Fischer, Erlangen (DE); Stefan Mijovic, Erlangen (DE); Riccardo Cavallari, Erlangen (DE); Umut Goekay, Mainz (DE)

(21) Appl. No.: 17/384,961

(22) Filed: Jul. 26, 2021

(30) Foreign Application Priority Data
Jul. 28, 2020 (EP) 20 188 238.8

(51) Int. Cl. H04R 25/00; H04R 1/10; H04M 1/72412; H04W 4/80

(52) U.S. Cl. CPC H04R 25/554; H04R 1/1025; H04R 25/552; H04W 4/80; H04M 1/72412

(57) ABSTRACT

A method is specified for establishing a short-range radio link, in particular a Bluetooth connection, between a first device and a second device. A charging unit, which is configured to charge a hearing device, mediates the establishment of the short-range radio link. The charging unit transmits pairing data of the first device to the second device to establish the short-range radio link, so that the latter device is paired with the first device and the short-range radio link is established. There are also described a hearing device and a charging unit.

### CROSS-REFERENCE TO RELATED APPLICATION

This application claims the priority, under 35 U.S.C. § 119, of European patent application EP 20 188 238.8, filed Jul. 28, 2020; the prior application is herewith incorporated by reference in its entirety.

### BACKGROUND OF THE INVENTION

### Field of the Invention

The invention relates to a method for establishing a short-range radio link, in particular a Bluetooth connection, between a first device and a second device. The invention further pertains to a hearing device, such as a hearing aid, and a charging unit.

A so-called short-range radio link is a connection by radio, e.g., at a transmission frequency of a few GHz over a short distance of, e.g., no more than a few tens of meters between two devices. The link is used for data transmission, i.e., for exchanging data between the two devices. An example of a short-range radio link is a Bluetooth connection. A short-range radio link is established between two devices by the devices exchanging pairing data prior to the actual connection, i.e. when the connection is being established, to pair the two devices and thus ultimately to establish the short-range radio link. Bluetooth technology in generic and well known, and the establishment of a Bluetooth connection in particular are described in the BLUETOOTH CORE SPECIFICATION Version 5.1, which can be retrieved at www.bluetooth.com, for example.

A hearing aid is normally used for treating a hearing-impaired user. To this end, the hearing aid has a microphone which captures sound from the surroundings and generates an electrical input signal. This is fed to a signal processor of the hearing aid for modification. The modification takes place in particular on the basis of an individual audiogram of the user assigned to the hearing aid, so that an individual hearing deficit of the user is compensated. As a result the signal processor outputs an electrical output signal which is then converted back into sound and output to the user via a receiver of the hearing aid.

A charging unit is generally used to charge another device by connecting that device to the charging unit. As soon as the device is connected to the charging unit and charging is performed, electrical power is transferred from the charging unit to the device. For example, it is possible that an energy storage device of a hearing aid can be charged and is charged by connecting the hearing aid to a suitable charging unit.

It is often necessary for a user to connect two devices for data exchange, specifically by means of a short-range radio link, since this guarantees a high degree of mobility and flexibility, while at the same time ensuring security due to the limited range. For example, it is possible to pair a hearing aid with a smartphone in order to control or adjust the hearing aid using the smartphone, or conversely to send data from the hearing aid to the smartphone and process it there, for example.

The pairing of two devices by means of a short-range radio link may cause problems for some users, especially those with little technical experience, and may also take a certain amount of time, which is why the setup procedure is designed to be as automatic as possible, or at least as simple as possible for a user to manage. This is all the more important if the short-range link is to be regularly re-established or if different devices are to be connected to one another in different configurations.

United Stated published patent application US 2017/0013342 A1 describes a method for the wireless pairing of an audio output device with a partner device. In that method the opening of a cover of a housing containing the audio output device is detected.

International publication WO 2007/097892 A2 describes a method for communicating with a hearing aid. In that case, an audible carrier frequency is transmitted and modulated with data and detected in the hearing aid with a filter.

### BRIEF SUMMARY OF THE INVENTION

Against this background, it is an object of the invention to improve the establishment of a short-range radio link between two devices and thereby simplify it as much as possible. To this end, an improved method for establishing a short-range radio link will be specified. In addition, an improved hearing device and an improved charging unit which are used in the method will be specified.

With the above and other objects in view there is provided, in accordance with the invention, a method for establishing a short-range radio link, such as a Bluetooth connection, between a first device and a second device, the method comprising:

providing a charging unit configured to charge a hearing device;

mediating an establishment of the short-range radio link by transmitting with the charging unit pairing data of the first device for establishing the short-range radio link to the second device; and

pairing the second device with the first device to establish the short-range radio link.

Advantageous configurations, extensions and variants form the subject matter of the dependent claims. There, the comments made with reference to the method apply, mutatis mutandis, also to the hearing aid and the charging unit, and vice versa. Where method steps of the method are described in the following, advantageous configurations for the hearing aid and the charging unit are obtained in particular by the fact that each of them is designed to execute one or more of these method steps.

The method is used to establish a short-range radio link, in particular a Bluetooth connection, between a first device and a second device. The two devices accordingly each have an interface for the short-range radio link, e.g. an antenna, in particular a Bluetooth antenna. The establishment of the short-range radio link is also referred to as pairing. In the case of a Bluetooth connection, this is preferably a low-energy Bluetooth connection, also known as BLE (i.e. “Bluetooth low energy”). The short-range radio link is characterized in particular by the fact that it has a limited range of at most a few tens of meters and a transmission frequency in the range of a few GHz.

In the method a charging unit, which is designed to charge a hearing device, such as a hearing aid, mediates the establishment of the short-range radio link between the two devices, by the charging unit transmitting pairing data of the first device to the second device to establish the short-range radio link so that the latter device is paired with the first device and the short-range radio link is established. The pairing data include in particular authentication data, identification data, encryption data, e.g. a so-called passkey, or a combination of these. In general, the pairing data is used for pairing the two devices and is required in advance of the actual pairing in order to establish the short-range radio link successfully. However, the exact nature of the pairing data is of no further significance in itself.

A core concept of the invention is in particular the use of a charging unit of a hearing aid for mediating the establishment of a short-range radio link between two devices, which then do not need to exchange the necessary pairing data with each other directly, but the pairing data is instead provided by the charging unit and transmitted to a respective device as required in order to connect it to another device. The charging unit is therefore also referred to as a master device. In particular, the charging unit itself does not exchange any other data with the two devices other than the pairing data, which takes place directly between the two devices after the short-range radio link has been established. In particular, the charging unit is thus not exactly a relay of the short-range radio link, but rather an intermediary in the establishment of the short-range radio link. The mediation by the charging unit facilitates the pairing of the two devices by means of the short-range radio link, since these no longer have to provide the pairing data themselves. This is particularly advantageous in arrangements in which the pairing data is not transmitted in the same way as the data, but in a different way which may require an interface that is unsuitable for use with one of the devices. For example, because of the lower transmission frequency, NFC antennas are typically larger than Bluetooth antennas, which means they require more space and are unsuitable for use in a hearing aid, whereas a Bluetooth antenna can usually be easily integrated into a hearing aid. Furthermore, the charging unit can be used to easily connect various devices to each other automatically and in a centralized manner, without the user having to perform this manually for each separate short-range radio link.

The first and second device can be provided by a wide variety of devices.

In a particularly preferred arrangement, the first device is the hearing device, here described and repeatedly referred to as a hearing aid, which can be charged with the charging unit so that the charging unit then mediates the establishment of a short-range radio link between the assigned hearing device and any other device.

Preferably, the second device is a mobile terminal device, in particular a smartphone. Alternatively, the second device is a TV set or any other device, in particular an audio source for the hearing aid, i.e. the second device provides an audio signal which is to be transmitted to the hearing aid via the short-range radio link and is designed to be, and advantageously also is, converted into sound and output by the hearing aid.

In principle, any combination of two devices is conceivable and suitable. In the case of a hearing aid, smartphone and a TV set, the charging unit then mediates between any two of these devices, but with a mediation between a hearing aid and another device being particularly advantageous since a hearing aid, in contrast to a mobile terminal and a TV device, is typically subject to much greater limitations in terms of space and energy consumption and therefore benefits particularly well from mediation by the associated charging unit.

As already indicated above, the method is particularly advantageous if the pairing data is intended to be transmitted or even must be transmitted by other means than the data that is transmitted via the short-range radio link after it has been established. In a preferred arrangement, the pairing data is accordingly transferred from the charging unit to the second device OOB (acronym for “out of band”), i.e. outside a transmission frequency range of the short-range radio link. The short-range radio link has a transmission frequency range which is used for the transmission of data. OOB is then understood to mean any frequency range that does not overlap or lie within this transmission frequency range. This is based on the consideration that a different type of connection may be more advantageous for the transmission than the short-range radio link itself.

In order to transmit the pairing data from the charging unit to the second device OOB, an NFC connection is particularly preferred, i.e. the pairing data is transmitted OOB via NFC (acronym for “near field communication”). NFC or near-field communication is essentially an alternative to Bluetooth, but typically has a lower transmission frequency and typically also a shorter range. For example, a transmission frequency of the NFC connection is below 1 GHz and in particular in the range from 1 MHz to 100 MHz. For example, the NFC connection has a maximum range of 1 cm.

The charging unit preferably has an N-Mark in which the pairing data of the first device is stored, and this pairing data is transmitted to the second device OOB by means of NFC. The N-Mark is therefore, in particular, a memory for the pairing data. For example, the pairing data has already been stored on the N-Mark during the manufacture of the charging unit or as part of a fitting session for the hearing aid and accordingly, for the associated charging unit as well. Alternatively or in addition, the pairing data are requested by the charging unit at the first or second device or at another device as required, and stored in the N-Mark.

An advantage of the transmission of the pairing data OOB with respect to the short-range radio link is, in particular, that the charging unit itself only needs to be designed for the transmission of data via OOB and does not need to be designed for transmission via the short-range radio link. For example, the charging unit is only designed to establish an NFC connection but not to establish a Bluetooth connection, although the latter is also advantageous in addition to the possibility of an NFC connection.

In a preferred arrangement, the charging unit detects the proximity of the second device to the charging unit, in particular by means of NFC, and then, e.g. after establishing an NFC connection to the second device, transmits the pairing data to the second device. The proximity of the second device to the charging unit is used here as a reliable indicator that a user wishes to pair the second device with the first device. An NFC connection is particularly suitable for the particularly secure detection of proximity, since accidental proximity is very unlikely due to the short range of the NFC antennas. The charging unit and the second device then advantageously each have an NFC antenna for establishing an NFC connection and for the OOB exchange of the pairing data. The described detection of an approach by the second device to the charging unit, particularly preferably the establishment of an NFC connection between the charging unit and the second device, thus serves advantageously to initiate the establishment of the short-range radio link, i.e. as a kind of switch, in order to initiate and implement the pairing of the two devices. In this way, the necessary proximity for the NFC connection is used as a reliable trigger, without the first device itself needing to be equipped with an NFC antenna and therefore preferably needing no NFC antenna. This is particularly advantageous with a hearing aid as the first device, since an NFC antenna cannot be readily integrated into a hearing aid. However, an NFC antenna can typically be integrated into the charging unit without difficulty and therefore the charging unit in the present case is preferably also fitted with an NFC antenna and more generally, an 00B antenna.

The first device can be connected to the charging unit for charging. “Connected” in this case means that an energy exchange between the first device and the charging unit is enabled for charging an energy storage unit of the first device. For the energy exchange, the first device and the charging unit are electrically connected or can be connected in an electrically isolated manner. Accordingly, the charging is carried out in a contactless manner, e.g. inductively by means of a coil pair, or by means of charging contacts on the charging unit and the first device. In any case, in order to make the connection it is typically necessary to move the charging unit and the first device into a specific spatial relation to each other, for example, to attach the first device to the charging unit, or plug or insert it into, or place it on the first device, among other arrangements.

In a preferred arrangement, the charging unit transmits the pairing data to the second device when the first device is connected to the charging unit, in particular for charging. This means that the short-range radio link is also established while the first device is connected to the charging unit. A disconnection of the first device from the charging unit to establish the short-range radio link is then advantageously unnecessary, which improves the handling of the various devices. Preferably, the charging unit does not transmit the pairing data to the second device until an additional switch of the charging unit is activated. In order to make the actual pairing of the devices controllable, the activation of the switch is additionally required to initiate the pairing. In this way, the user can use a simple switch to check when the first and second devices are coupled. This is possible and advantageous, in particular, as an alternative or in addition to the use of an NFC connection described above as a kind of virtual switch. The previous comments apply analogously here.

In a preferred arrangement, the charging unit comprises a holder and the first device can be connected to the charging unit by inserting it into the holder. In a practical design the holder is a shell. The switch is preferably arranged in the holder and can be activated by inserting the first device into the holder or by removing the first device from the holder. The switch is, for example, a mechanical switch which is pressed down by the first device when the latter is inserted, or which is released when the first device is removed, or vice versa. A combination of these is also possible. Non-mechanical switches, e.g. proximity switches, are also suitable.

Alternatively or additionally, in a suitable arrangement the charging unit comprises a holder and a cover and the first device can be connected to the charging unit by inserting it into the holder, and the cover can be folded open and closed to remove the first device from the holder or to insert the first device into the holder. The above comments also apply to the holder. When the cover is closed, it locks the holder in particular, whereas when the cover is opened, the holder is accessible from the outside. When the lid is being opened or closed, the charging unit sends the pairing data to the second device, preferably but not necessarily when the first device is connected to the charging unit. For this purpose, the cover activates, for example, a mechanical or non-mechanical switch as described above. In this way, an automatic pairing, i.e. an automatic establishment of the short-range radio link, is implemented when opening or closing the charging unit shortly before removing the first device from the charging unit or shortly before inserting it. A combination of these is also possible. In general it is particularly advantageous that a pairing is initiated automatically by activating the cover (i.e. folding it open or closed). Specifically when the lid is folded out, i.e. when the charging unit is opened, it is safe to assume that the first device will subsequently also be removed and thus separated from the charging unit, in particular with the intention to use the first device, in the case of a hearing aid, for example, to place it in or on an ear and to wear it for its intended purpose. For this reason, specifically in this situation, the short-range radio link is established automatically so that the user does not need to do this manually. However, establishing the short-range radio link during insertion is also generally advantageous, e.g. to adjust the hearing aid or perform updates while it is not being worn.

The transmission of the pairing data to the second device when the lid is being opened or closed is generally advantageous, regardless of whether the first device is actually connected to the charging unit or not. However, a particularly practical arrangement is one in which the charging unit transmits the pairing data to the second device only when the first device is connected to the charging unit, i.e. inserted into the holder when the device is opened or closed.

Alternatively or additionally, a pairing is also advantageous if the first device is not currently connected to the charging unit but rather disconnected from it and being used for its intended purpose, for example, as described above. Therefore, in a suitable arrangement, if the first device is not connected to the charging unit the pairing data is transmitted to the second device as soon as the charging unit detects the proximity of the second device to the charging unit. The proximity is detected in particular as described above, e.g. by means of NFC or by means of a distance sensor.

In a practical arrangement, the charging unit receives the pairing data of the first device from said device via a further short-range radio link, in particular a further Bluetooth connection, between the charging unit and the first device. This advantageously enables the pairing data to be updated or changed, for example in case the first device is replaced by another first device. The pairing data obtained in this way is advantageously stored in the N-Mark mentioned above, if one is available. A “further short-range radio link” means a further short-range radio link in addition to the short-range radio link between the first and the second device, as opposed to meaning that two short-range radio links have been formed between the first device and the charging unit.

In an advantageous arrangement, the charging unit detects a connection of the first device by means of proximity detection, e.g. in the context of a so-called “proximity pairing” by means of RSSI (acronym for “received signal strength indication”), whereupon a short-range radio link is established between the charging unit and the first device for the automatic transmission of the pairing data to the charging unit. In other words, the charging unit detects that the first device is located near the charging unit and then automatically retrieves the pairing data from the charging unit via a short-range radio link, in particular a Bluetooth connection, so that the pairing data can then be forwarded to a second device as necessary if a short-range radio link is to be established between the first and the second device.

As soon as the pairing data has been transferred from the charging unit to the second device, the charging unit itself is no longer actually required to establish a further link between the first device and another, third device, because the second device can now also advantageously mediate the establishment of a further short-range radio link between the first device and the third device in the same way. In a suitable arrangement the second device therefore transmits the pairing data directly to the third device to establish a further short-range radio link between the first device and a third device.

Without limiting the generality of the previous comments, a specific combination of more than one of the concepts mentioned above is particularly preferred, namely an arrangement in which the first device is a hearing aid which can be charged by means of the charging unit and which is paired with a second device via a Bluetooth connection, mediated by the charging unit, which takes place while the hearing aid is connected to the charging unit and by the pairing data being transmitted from the charging unit to the second device OOB, preferably via an NFC connection, to establish the Bluetooth connection. The transmission of the pairing data and the establishment of the Bluetooth connection are carried out automatically as soon as the connection for an OOB transmission, in particular the NFC connection, is established. In the following, it is assumed without restriction of generality that the connection for the OOB transmission is an NFC connection. The NFC connection itself is established automatically as soon as the second device has approached sufficiently close to the charging unit, i.e. in particular, is located within range of an NFC antenna of the charging unit for the NFC connection. Apart from this specific arrangement, however, other combinations of the described concepts and thus other arrangements are entirely advantageous.

A hearing device, which is generally referred to as a hearing aid but is not limited to such a device, is designed to be connected as the first device to a second device according to a method as described above. For this purpose, the hearing device comprises in particular an antenna which is suitable for short-range radio links, e.g. a Bluetooth antenna.

The hearing aid is preferably used for treating a hearing-impaired user. To this end, the hearing aid has a microphone which captures sound from the environment and generates an electrical input signal. This is fed to a signal processor of the hearing aid for modification. The signal processor is preferably a part of the control unit. The modification takes place in particular on the basis of an individual audiogram of the user, which is assigned to the hearing aid so that an individual hearing deficit of the user is compensated. As a result the signal processor outputs an electrical output signal, which is then converted back into sound and output to the user via a receiver of the hearing aid.

As an alternative, the hearing device is designed only to output sound from an audio source and accordingly has a receiver for sound output, and an input for receiving an electrical audio signal from the audio source. In a suitable arrangement, the hearing device is a set of headphones.

Preferably, the hearing device is a binaural hearing device or hearing aid with two individual devices, which are worn by the user on different sides of the head during the intended usage, namely one in or on the left ear and one in or on the right ear.

With the above and other objects in view there is also provided, in accordance with the invention, a charging unit that is configured to carry out a method as described above.

Other features which are considered as characteristic for the invention are set forth in the appended claims.

Although the invention is illustrated and described herein as embodied in method for establishing a short-range radio link, and a hearing device and charging unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a charging unit, a first device and a second device;

FIG. 2 shows the devices from FIG. 1 and a third device and their connection to one another; and

FIG. 3 shows a flow diagram of a method for establishing a short-range radio link.

### DETAILED DESCRIPTION OF THE INVENTION

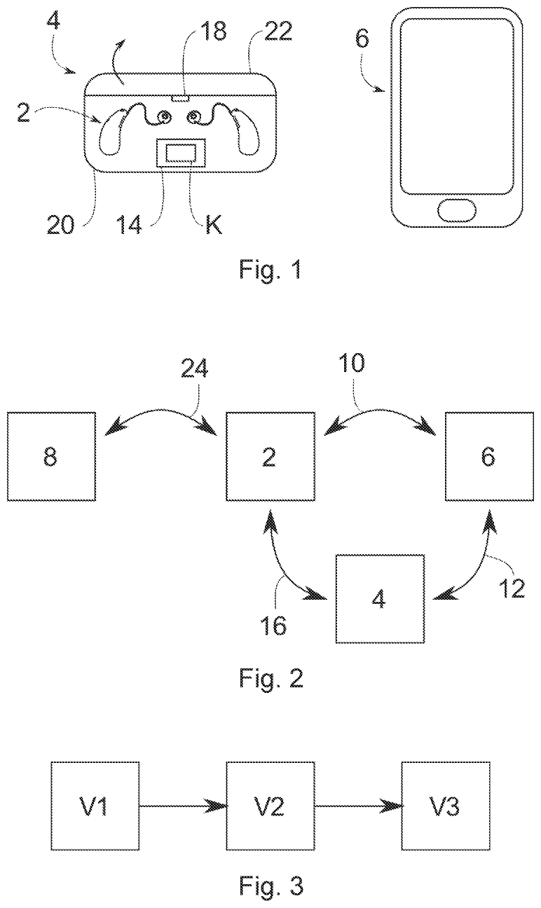

FIG. 1 shows a hearing device 2, which may be a hearing aid, a charging unit 4 which is designed to charge this hearing device 2, and a smartphone 6. The hearing aid 2 is a first device 2, the smartphone 6 is a second device 6. The charging unit 4 is also generally referred to as the device 4. FIG. 2 shows the devices 2, 4, 6 in a highly simplified form in order to illustrate their connection to one another. In addition, FIG. 2 shows an optional third device 8, e.g. a TV set.

FIG. 3 shows a flow diagram of an exemplary embodiment of a method for establishing a short-range radio link 10, in this case a Bluetooth connection, between the first device 2 and a second device 6, i.e. the hearing device 2 and the smartphone 6. The two devices 2, 6 each comprise an interface for the short-range radio link 10, which is not explicitly shown, in this case a Bluetooth antenna. The establishment of the short-range radio link 10 is also referred to as pairing. The short-range radio link 10 in the present case is characterized in particular by the fact that it has a limited range of at most a few tens of meters, and a transmission frequency in the range of a few GHz.

In the method, the charging unit 4 mediates the establishment of the short-range radio link 10 between the two devices 2, 6 by the charging unit 4 transmitting pairing data K of the first device 2 for establishing the short-range radio link 10 to the second device 6, so that the latter is paired with the first device 2 and the short-range radio link 10 is established. The pairing data K includes, for example, authentication data, identification data, encryption data, e.g. a so-called passkey, or a combination of these. In general, the pairing data K is used for pairing the two devices 2, 6 and is required in advance of the actual pairing in order to successfully establish the short-range radio link 10. However, the exact nature of the pairing data K is of no further significance in itself.

By using the charging unit 4 of the hearing device 2 to mediate the establishment of the short-range radio link 10 between the two devices 2, 6, these no longer need to exchange the necessary pairing data K directly with each other, the pairing data K instead being provided by the charging unit 4 and transmitted to a respective device 6, 8 as required in order to connect it to another device 2, 6, 8. The charging unit 4 is therefore also referred to as a master device. In the present case, the charging unit 4 itself does not exchange any other data with the two devices 2, 6 other than the pairing data K, this takes place directly between the two devices 2, 6 after the short-range radio link 10 has been established. The charging unit 4 is thus not exactly a relay of the short-range radio link 10, but instead an intermediary in the establishment of the short-range radio link 10.

In the exemplary embodiment shown, the first device 2 is a hearing device 2 which can be charged with the charging unit 4, so that the charging unit 4 then mediates the establishment of a short-range radio link 10 between the assigned hearing device 2 and any other device 6, 8. In the exemplary embodiment shown, the second device 6 is a mobile terminal device, specifically a smartphone 6. Alternatively, the second device 6 is a TV set or any other device, such as an audio source for the hearing device 2. In principle, any combination of two devices 2, 6, 8 is possible. In the case of a hearing device 2, a smartphone 6 and a third device 8, e.g. a TV set, the charging unit 4 then mediates between any two of these devices 2, 6, 8, but with the mediation between a hearing device 2 and another device 6, 8 being particularly practical since a hearing device 2, in contrast to a mobile terminal and a TV set, is typically subject to much greater limitations in terms of space and energy consumption and therefore benefits particularly well from mediation by the associated charging unit 4.

As part of the method, the pairing data K is transmitted in a different way than the data which is transmitted over the short-range radio link 10 once it has been established. In the exemplary embodiment shown, the pairing data K is transferred from the charging unit 4 to the second device 6 OOB (acronym for “out of band”), i.e. outside of a transmission frequency range of the short-range radio link 10. The short-range radio link 10 has a transmission frequency range which is used for the transmission of data. OOB is then understood to mean any frequency range that does not overlap or lie within this transmission frequency range.

In order to transmit the pairing data K OOB from the charging unit 4 to the second device 6, in the exemplary embodiment shown an NFC connection 12 is used, i.e. the pairing data K is transmitted OOB by means of NFC (acronym for “near field communication”). NFC is also known as near-field communication and is essentially an alternative to Bluetooth, but it typically has a lower transmission frequency and typically also a shorter range. For example, a transmission frequency of the NFC connection 12 is below 1 GHz and in particular in the range from 1 MHz to 100 MHz. For example, the NFC connection 12 has a maximum range of 1 cm. In the following, without restriction of generality an NFC connection 12 is assumed, but this is entirely interchangeable with any other OOB connection, i.e. OOB with respect to the short-range radio link 10.

In the exemplary embodiment shown the charging unit 4 has an N-Mark 14 in which the pairing data K of the first device is 2 stored, and this pairing data K is transmitted OOB to the second device 6 by means of NFC, namely via the NFC connection 12 as shown in FIG. 2. For example, the pairing data K has already been stored on the N-Mark 14 during the manufacture of the charging unit 4 or as part of a fitting session for the hearing device 2 and accordingly, for the associated charging unit 4 as well. Alternatively or in addition, the pairing data K is requested by the charging unit 4 as required from the first or second device 2, 6 or from another device 8, and stored in the N-Mark 14. Thus FIG. 2 shows an example of an optional, further short-range radio link 16 between the charging unit 4 and the hearing device 2, via which the pairing data K is transmitted. Due to the transmission of the pairing data K OOB with respect to the short-range radio link 10, in principle the charging unit 4 itself only needs to be designed for the transmission of data via OOB and does not necessarily need to be designed for transmission via a short-range radio link 10, 16. For example, in an arrangement not explicitly shown, the charging unit 4 is designed only to establish an NFC connection 12, but not to establish a Bluetooth connection. It is also entirely possible and practical to replace the further short-range radio link 16 in FIG. 2 by an NFC connection and in general, an OOB connection.

In the exemplary embodiment shown, the charging unit 4 detects the proximity of the second device 6 to the charging unit 4 by means of NFC and then, e.g. after establishing the NFC connection 12 to the second device 6, transmits the pairing data K to the second device 6. The proximity of the second device 6 to the charging unit 4 acts as a reliable indicator that a user desires to create a pairing of the second device 6 with the first device 2. An NFC connection 12 is particularly suitable for the highly secure detection of proximity, since an accidental proximity is then very unlikely due to the short range of the NFC antennas, not explicitly shown. The charging unit 4 and the second device 6 then each comprise an NFC antenna for establishing the NFC connection 12 and for the 00B exchange of the pairing data K. The described detection of proximity of the second device 6 to the charging unit 4 is used here to initiate the establishment of the short-range radio link 10, i.e. as a kind of switch, to initiate and carry out the pairing of the two devices 2, 6. In this way, the necessary proximity for the NFC connection 12 is used as a reliable trigger, without the first device 2 itself needing to be equipped with an NFC antenna. Specifically when the first device 2 is a hearing device 2, an NFC antenna cannot readily be integrated into the hearing device 2. However, an NFC antenna can typically be integrated into the charging unit 4 without problems.

The first device 2 can be connected to the charging unit 4 for charging. In FIG. 1, the hearing device 2 is also actually connected to the charging unit 4 for charging. “Connected” in this case means that an energy exchange between the first device 2 and the charging unit 4 is enabled for charging an energy storage unit of the first device 2. In the present case, the charging is carried out in a contactless manner, e.g. inductively by way of a coil pair, or alternatively by way of charging contacts on the charging unit 4 and the first device 2. In any case, to make the connection it is typically necessary to move the charging unit 4 and the first device 2 into a specific spatial relationship, namely in FIG. 1 to insert the first device 2 into the charging unit 4.

In the exemplary embodiment shown the charging unit 4 transmits the pairing data K to the second device 6 when the first device 2 is connected to the charging unit 4, for example, inserted into the charging unit for charging, as shown in FIG. 1. This means that the short-range radio link 10 is also established while the first device 2 is connected to the charging unit 4. It is not necessary to disconnect the first device 2 from the charging unit 4 to establish the short-range radio link 10.

In the present case the charging unit 4 also transmits the pairing data K to the second device 6 when a switch 18 of the charging unit 4 is additionally activated. In order to make the actual pairing of the devices 2, 6, 8 controllable, the activation of the switch 18 is additionally required to initiate the pairing. In this way, the user can use a simple switch 18 to check specifically when the first and second devices 2, 6 are coupled. In the exemplary embodiment shown, this is possible in addition to the above-described use of an NFC connection 12 as a kind of virtual switch, i.e. a user can initiate the establishment of the short-range radio link 10 in two different ways.

As can be seen from FIG. 1, the example of a charging unit 4 shown here comprises a holder 20, here designed in the shape of a shell or a cradle, and the first device 2 can be connected to the charging unit 4 by inserting it into the holder 10. In a variant that is not explicitly shown, the switch 18 is arranged in the holder 20 and can be activated by inserting the first device 2 into or removing it from the holder 20 and pressing it down, for example during insertion. In the arrangement shown in FIG. 1, in addition to the holder 20, the charging unit 4 has a cover 22 which can be folded out for removing the first device 2 from the holder 20 or inserting it, as indicated by an arrow. Similarly, the cover 22 can be folded down in the other direction so that it then covers the holder 20. When the first device 2 is connected to the charging unit 4, the charging unit 4 transmits the pairing data K to the second device 6 when the cover 22 is opened or closed. For this purpose the cover 22 activates the switch 18, for example. In this way, an automatic coupling, i.e. an automatic establishment of the short-range radio link 10, is implemented when opening or closing the charging unit 4, e.g. shortly before removing the first device 2 from the charging unit 4. In general, however, it is not necessary to connect the first device 2 to the charging unit 4 for the coupling to take place.

In an arrangement not explicitly shown, a pairing also takes place alternatively or additionally when the first device 2 is not currently connected to the charging unit 4, but rather is separated from it and being used for the intended purpose, for example. In such an arrangement, if the first device 2 is not connected to the charging unit 4, the pairing data K is transmitted to the second device 6 as soon as the charging unit 4 detects the proximity of the second device 6 to the charging unit 4. The proximity is detected, for example, as described above, using NFC or alternatively or additionally by means of a distance sensor.

FIG. 2 shows how the charging unit 4 optionally receives the pairing data K of the first device 2 from this device via an additional short-range radio link 16, here an additional Bluetooth connection, between the charging unit 4 and the first device 2. The charging unit 4 detects the connection of the first device 2 by means of proximity detection, e.g. as part of a so-called “proximity pairing” by means of RSSI (acronym for “received signal strength indication”), whereupon the short-range radio link 16 is established between the charging unit 4 and the first device 2 for the automatic transmission of the pairing data K to the charging unit 4. In other words, the charging unit 4 detects that the first device 2 is located near the charging unit 4 and then automatically retrieves the pairing data K from the latter via the additional short-range radio link 16, so that the pairing data K can then be forwarded to a second device 6 if necessary if a short-range radio link 10 is to be established between the first and the second devices 2, 6.

As soon as the pairing data K has been transferred from the charging unit 4 to the second device 6, the charging unit 4 itself is no longer required to establish an additional link 24 between the first device 2 and another, third device 8, because the second device 6 can now also advantageously mediate the establishment of a further short-range radio link between the first device 2 and the third device 8 in the same way. For example, the second device 6 therefore transmits the pairing data K directly to the third device 8, to establish in this case the third short-range radio link 24 between the first device 2 and a third device 8.

In the exemplary method shown in FIG. 3, in the third method step V3 the hearing device 2 is paired with a second device 6 via a Bluetooth connection 10 via the mediation of the charging unit 4 while the hearing device 2 is connected to the charging unit 4. The pairing data K for establishing the Bluetooth connection 10 are transmitted OOB beforehand in the second method step V2, in this case via the NFC connection 12, from the charging unit 4 to the second device 6. The transmission of the pairing data K and the establishment of the Bluetooth connection 10 are carried out automatically as soon as the NFC connection 12 has been established. The NFC connection 12 itself is established automatically in the first method step V1 as soon as the second device 6 has approached sufficiently near to the charging unit 4, i.e. in the present case, is located within range of an NFC antenna of the charging unit 4 for the NFC connection 12. Apart from this arrangement, however, other combinations of the described concepts and thus other arrangements are entirely possible. For example, the first method step V1 alternatively or additionally comprises the detection of an activation of the switch 18, whereupon the pairing data K is then transmitted in the second method step V2. Before the first method step V1, or at least before the second method step V2, an additional method step is also possible in which the pairing data K is transmitted to the charging unit 4, e.g. as described above.

The exemplary hearing device 2 shown in the figures, is used to treat a hearing-impaired user. To this end, the hearing device 2 has a microphone which captures sound from the surroundings and generates an electrical input signal. This is fed to a signal processor of the hearing device for modification. The modification is carried out in particular on the basis of an individual audiogram of the user assigned to the hearing device 2, so that an individual hearing deficit of the user is compensated. As a result, the signal processor outputs an electrical output signal which is then converted back into sound and output to the user via a receiver of the hearing device 2. The hearing device 2 shown is also a binaural hearing device 2 with two individual devices, as shown in FIG. 1, which are worn by the user on different sides of the head during the intended usage, namely one in or on the left ear and one in or on the right ear.

As an alternative, the hearing device 2 is designed only to output sound from an audio source and accordingly comprises a receiver for the sound output, and an input for receiving an electrical audio signal from the audio source. In a suitable arrangement, the hearing device 2 is a set of headphones.

The following is a summary list of reference numerals and the corresponding structure used in the above description of the invention:
2 hearing device, first device
4 charging unit
6 smartphone, second device
8 third device
10 short-range radio link, Bluetooth connection
12 NFC connection
14 N-Mark
16 additional short-range radio link
18 switch
20 holder
22 cover
24 additional connection, third short-range radio link
K pairing data
V1 first method step
V2 second method step
V3 third method step

1. A method for establishing a short-range radio link between a first device and a second device, the method comprising:
providing a charging unit configured to charge a hearing device;
mediating an establishment of the short-range radio link by transmitting with the charging unit pairing data of the first device for establishing the short-range radio link to the second device; and
pairing the second device with the first device to establish the short-range radio link.

2. The method according to claim 1, wherein the short-range radio link is a Bluetooth connection.

3. The method according to claim 1, wherein the first device is the hearing device and the second device is a mobile terminal device.

4. The method according to claim 3, wherein the second device is a smartphone.

5. The method according to claim 1, which comprises transmitting the pairing data from the charging unit to the second device outside a transmission frequency range of the short-range radio link.

6. The method according to claim 5, wherein the charging unit has an N-Mark in which the pairing data of the first device is stored, and the method comprises transmitting the pairing data to the second device OOB by near-field communication.

7. The method according to claim 1, which comprises detecting with the charging unit a proximity of the second device to the charging unit and then transmitting the pairing data to the second device.

8. The method according to claim 7, which comprises detecting the proximity by near-field communication.

9. The method according to claim 1, which comprises transmitting the pairing data from the charging unit to the second device when the first device is connected to the charging unit and a switch of the charging unit is additionally actuated.

10. The method according to claim 9, wherein the charging unit comprises a holder and the first device is connected to the charging unit by inserting the first device into the holder, and wherein the switch is arranged in the holder and configured for activation by inserting the first device into the holder or by removing the first device from the holder.

11. The method according to claim 1, which comprises:
providing the charging unit with a holder and a cover, and selectively connecting the first device to the charging unit by inserting the first device into the holder;
selectively folding open or closing the cover for removing the first device from the holder or for inserting the first device into the holder; and
transmitting the pairing data from the charging unit to the second device when the cover is being opened or being closed.

12. The method according to claim 1, which comprises, if the first device is not connected to the charging unit, transmitting the pairing data to the second device as soon as the charging unit detects a proximity of the second device to the charging unit.

13. The method according to claim 1, which comprises receiving with the charging unit the pairing data of the first device from the first device via an additional short-range radio link between the charging unit and the first device.

14. The method according to claim 13, wherein the additional short-range radio link is an additional Bluetooth connection.

15. The method according to claim 1, which comprises detecting with the charging unit a connection of the first device by proximity detection and subsequently establishing a short-range radio link between the charging unit and the first device, for an automatic transmission of the pairing data to the charging unit.

16. The method according to claim 1, which comprises, in order to establish an additional short-range radio link between the first device and a third device, transmitting the pairing data from the second device directly to the third device.

17. A hearing device, configured as the first device in the method according to claim 1 for connecting the hearing device to a second device.

18. The hearing device according to claim 17 being a hearing aid.

19. A charging unit, configured to carry out the method according to claim 1.
